(19) United States
(12) Patent Application Publication
(10) Pub. No.: US 2025/0320132 A1
(43) Pub. Date: Oct. 16, 2025

(54) COMPOSITE HYDROXIDE, COMPOSITE OXIDE, AND PRODUCTION METHODS

(71) Applicant: Prime Planet Energy & Solutions, Inc., Tokyo (JP)

(72) Inventor: Junichi SUGIYAMA, Kobe-shi (JP)

(21) Appl. No.: 19/096,719

(22) Filed: Apr. 1, 2025

(30) Foreign Application Priority Data
Apr. 15, 2024 (JP) 2024-065331

(51) Int. Cl. C01G 53/84; C01G 53/44; H01M 4/525

(52) U.S. Cl. CPC C01G 53/84; C01G 53/44; C01P 2002/50; C01P 2002/74; C01P 2004/03; C01P 2004/50; C01P 2004/61; C01P 2006/12; C01P 2006/40; H01M 4/525

(57) ABSTRACT

A method of producing a composite hydroxide according to the present disclosure includes: by supplying an aqueous ammonia solution and sodium hydroxide to an aqueous solution including a compound containing nickel and a compound containing manganese, generating a nucleus while maintaining a pH at 12.0 to 13.5 on condition of a liquid temperature of 25° C. and an ammonium ion concentration at 5.3 to 11.7 g/L; and growing the nucleus while maintaining the pH at 9.7 to 10.8 on condition of the liquid temperature of 25° C. and the ammonium ion concentration at 20.0 to 26.4 g/L.

### CROSS REFERENCE TO RELATED APPLICATIONS

This nonprovisional application is based on Japanese Patent Application No. 2024-065331 filed on Apr. 15, 2024 with the Japan Patent Office, the entire contents of which are hereby incorporated by reference.

### BACKGROUND OF THE INVENTION

### Field of the Invention

The present disclosure relates to a method of producing a composite hydroxide, and also relates to the composite hydroxide, a method of producing a composite oxide, and the composite oxide.

### Description of the Background Art

Japanese Patent Laying-Open No. 2016-210674 describes a nickel-cobalt composite hydroxide and a method of producing the same.

### SUMMARY OF THE INVENTION

In a process of producing a positive electrode active material used in a non-aqueous electrolyte secondary battery, a precursor of the positive electrode active material may be subjected to a calcination process at a relatively high temperature in order to obtain secondary particles in each of which a relatively small number of primary particles are aggregated, from the viewpoint of durability with regard to cracking of particles. However, when the nickel-cobalt composite hydroxide described in Japanese Patent Laying-Open No. 2016-210674 is subjected to such a calcination process at a relatively high temperature, the secondary particles are frequently sintered in a state in which the secondary particles are aggregated. As a result, a packing property in the positive electrode active material layer may be decreased. In order to improve the packing property in the positive electrode active material layer, a pulverization step of pulverizing the aggregated secondary particles is required in the process of producing the positive electrode active material, with the result that the number of steps is increased.

An object of the present disclosure is to provide: a composite hydroxide that is secondary particles in each of which a plurality of primary particles are aggregated and that contains nickel and manganese, wherein the secondary particles are suppressed from being sintered in a state in which the secondary particles are aggregated; a method of producing the composite hydroxide; a composite oxide produced using the composite hydroxide; and a method of producing the composite oxide.

[1] A method of producing a composite hydroxide, wherein
the composite hydroxide contains nickel and manganese,
the method comprising:
by supplying an aqueous ammonia solution and sodium hydroxide to an aqueous solution including a compound containing nickel and a compound containing manganese, generating a nucleus while maintaining a pH at 12.0 to 13.5 on condition of a liquid temperature of 25° C. and an ammonium ion concentration at 5.3 to 11.7 g/L; and
growing the nucleus while maintaining the pH at 9.7 to 10.8 on condition of the liquid temperature of 25° C. and the ammonium ion concentration at 20.0 to 26.4 g/L.

[2] The method of producing a composite hydroxide according to [1], wherein the composite hydroxide is a compound represented by the following formula (i):
Ni_{1-x-y-z}COₓMn_{y}M_{z} (i), where
0<x<0.5, 0<y<0.5, and 0≤z<0.05, and
M is one or more elements selected from a group consisting of Al, Ti, Zr, B, Mg, Fe, Cu, Zn, Sn, Na, K, Ba, Sr, Ca, W, Mo, Nb, Si, V, Cr and Ge.

[3] The method of producing a composite hydroxide according to [1] or [2], wherein each of the generating the nucleus and the growing the nucleus is performed in a non-oxidizing atmosphere.

[4] A method of producing a composite oxide, the method comprising the method of producing a composite hydroxide according to any one of [1] to [3].

[5] The method of producing a composite oxide according to [4], the method not comprising pulverizing.

[6] A composite hydroxide, wherein
the composite hydroxide is secondary particles in each of which a plurality of primary particles are aggregated,
a crystallite size Sp in a direction parallel to a (001) plane is 300 nm to 500 nm,
a crystallite size Sv in a direction perpendicular to the (001) plane is 100 nm to 300 nm, a ratio (Lp/Lv) of a length Lp of each of the primary particles in the direction parallel to the (001) plane to a length Lv of the primary particle in the direction perpendicular to the (001) plane when observed with a scanning electron microscope is 10 or more,
at least a part of the plurality of primary particles is aggregated randomly,
an average particle size of the secondary particles is 2.0 to 7.0 μm, and
the composite hydroxide contains nickel and manganese.

[7] The composite hydroxide according to [6], wherein a BET specific surface area of the secondary particles is 10 m²/g or less.

[8] The composite hydroxide according to [6] or [7], wherein a ratio (I011/I001) of an intensity I011 of a diffraction peak of a (011) plane to an intensity I001 of a diffraction peak of the (001) plane in each of the secondary particles is found by an X-ray diffraction method to be 1.00 or more.

[9] A composite oxide comprising a calcined product of a mixture of the composite hydroxide according to any one of [6] to [8] and lithium.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a scanning electron microscope image of a composite hydroxide produced in an Example 1.

FIG. 2 is a diagram for illustrating a direction perpendicular to a (001) plane and a direction parallel to the (001) plane in a primary particle.

FIG. 3 shows a scanning electron microscope image of a composite oxide produced in Example 1.

FIG. 4 shows a scanning electron microscope image of a composite hydroxide produced in a Comparative Example 4.

FIG. 5 shows a scanning electron microscope image of a composite oxide produced in Comparative Example 4.

### DESCRIPTION OF THE PREFERRED EMBODIMENTS

### Method of Producing Composite Hydroxide

In a method of producing a composite hydroxide according to the present disclosure, the composite hydroxide contains nickel (Ni) and manganese (Mn), the method including: a nucleation step of, by supplying an aqueous ammonia solution and sodium hydroxide to an aqueous solution (hereinafter, also referred to as a source material metal hydroxide) including a compound containing Ni and a compound containing Mn, generating a nucleus while maintaining a pH at 12.0 to 13.5 on condition of a liquid temperature of 25° C. and an ammonium ion concentration at 5.3 to 11.7 g/L; and a nucleus growth step of growing the nucleus while maintaining the pH at 9.7 to 10.8 and the ammonium ion concentration at 20.0 to 26.4 g/L.

The composite hydroxide can be, for example, a precursor of a positive electrode active material to be used for an active material layer included in a positive electrode of a non-aqueous electrolyte secondary battery (hereinafter, also referred to as secondary battery) such as a lithium ion battery. The positive electrode active material can be produced by, for example, mixing the composite hydroxide and lithium and performing a calcination process thereto. The composite hydroxide may be in the form of particles, or may be secondary particles in each of which primary particles are aggregated.

In addition to Ni and Mn, the composite hydroxide may further include at least one element (hereinafter, also referred to as additive element) selected from a group consisting of Co, Al, Ti, Zr, B, Mg, Fe, Cu, Zn, Sn, Na, K, Ba, Sr, Ca, W, Mo, Nb, Si, V, Cr, and Ge. The composite hydroxide is preferably a composite hydroxide (hereinafter, also referred to as NCM composite hydroxide) including Ni, Mn and Co.

The NCM composite hydroxide can be, for example, a compound represented by the following formula (i):
Ni_{1-x-y-z}CoₓMn_{y}M_{z} (i), where
0<x<0.5, 0<><0.5, and 0≤z<0.05, and

M is one or more elements selected from a group consisting of Al, Ti, Zr, B, Mg, Fe, Cu, Zn, Sn, Na, K, Ba, Sr, Ca, W, Mo, Nb, Si, V, Cr and Ge. The composition of the composite hydroxide can be found by, for example, ICP (Inductively Coupled Plasma) emission spectroscopy.

### Nucleation Step

The nucleation step can be performed, for example, in the following manner: the aqueous source material metal solution is introduced into a reaction vessel, the aqueous ammonia solution and the sodium hydroxide are supplied to the reaction vessel, and stirring is performed while maintaining the pH on condition of the liquid temperature of 25° C. and the ammonium ion concentration to respectively fall in the predetermined ranges. The pH on condition of the liquid temperature of 25° C. and the ammonium ion concentration can also be adjusted by introducing the aqueous source material metal solution into the reaction vessel together with the aqueous ammonia solution, and then supplying the aqueous ammonia solution and the sodium hydroxide to the reaction vessel.

The aqueous source material metal solution is prepared by adding a compound containing nickel and a compound containing manganese to water. The compound containing Ni may be, for example, nickel sulfate (NiSO₄), nickel nitrate [Ni(NO₃)₂], nickel carbonate (NiCO₃), or the like. The compound containing Mn may be manganese sulfate (MnSO₄), manganese nitrate [Mn(NO₃)₂], manganese carbonate (MnCO₃), or the like. The aqueous source material metal solution may further include, for example, at least one element (hereinafter, also referred to as additive element) selected from a group consisting of Co, Al, Ti, Zr, B, Mg, Fe, Cu, Zn, Sn, Na, K, Ba, Sr, Ca, W, Mo, Nb, Si, V, Cr, and Ge. Among them, Co is preferable. The additive element may be added to the aqueous source material metal solution in the form of the element itself or in the form of a salt (for example, in the form of sulfate, nitrate, carbonate, or the like). When the additive element is Co, the aqueous source material metal solution can include a compound containing Co. The compound containing Co may be, for example, cobalt sulfate (CoSO₄), cobalt nitrate [Co(NO₃)₂], cobalt carbonate (CoCO₃), or the like.

A molar ratio (Ni:Mn) of Ni and Mn in the aqueous source material metal solution may be 1-x: 0<x<0.5, may be 1-x: 0.1<x<0.5, or may be 1-x: 0.2<x<0.4, for example.

When the aqueous source material metal solution contains Co, a molar ratio (Ni:Mn:Co) of Ni, Mn, and Co in the aqueous source material metal solution may be 1-x-y:0<x<0.5: 0<y<0.5, may be 1-x-y:0.05<x<0.25:0.05<y<0.25, or may be 1-x-y:0.1<x<0.2:0.1<y<0.2, for example.

When the aqueous source material metal solution includes Co and another additive element, a molar ratio of Ni, Mn, Co and the other additive element (Ni:Co:Mn: the other additive element) in the aqueous source material metal solution may be 1-x-y-z:0<x<0.5: 0<y<0.5: 0<z<0.05, may be 1-x-y-z:0.05<x<0.25:0.05<y<0.25:0.001<z<0.01, or may be 1-x-y-z:0.1<x<0.2:0.1<y<0.2:0.001<z<0.005, for example.

A metal content in the aqueous source material metal solution may be, for example, 0.5 to 2.0 mol/L.

The aqueous ammonia solution may have a pH of, for example, 11.5 to 13.5 on condition of the liquid temperature of 25° C. The aqueous ammonia solution may have an ammonium ion concentration of, for example, 5 to 15 g/L. The aqueous ammonia solution can be prepared by adding an aqueous sodium hydroxide solution and water to ammonium-containing water (distinguished from the aqueous ammonia solution; hereinafter, also referred to as ammonia water) such that the pH on condition of the liquid temperature of 25° C. and the ammonium ion concentration fall within the above-described ranges respectively. The aqueous ammonia solution can be prepared, for example, in an oxidizing atmosphere. The aqueous ammonia solution can be prepared while performing heating, for example, at a temperature of 25 to 50° C.

The nucleation step can be a step of performing crystallization by supplying the aqueous source material metal solution and the aqueous ammonia solution to the reaction vessel and performing stirring while maintaining the pH at 12.0 to 13.5 on condition of the liquid temperature of 25° C. and the ammonium ion concentration at 5.3 to 11.7 g/L. Since the nucleation step is performed while the pH on condition of the liquid temperature of 25° C. and the ammonium ion concentration respectively fall within the above-described ranges, the composite hydroxide, in which the secondary particles are suppressed from being sintered in a state in which the secondary particles are aggregated, tends to be likely to be obtained.

In the nucleation step, the aqueous source material metal solution and the aqueous ammonia solution can be supplied to the reaction vessel such that the molar ratio of the aqueous source material metal solution and the aqueous ammonia solution is 1:1.

While monitoring the pH on condition of the liquid temperature of 25° C. and the ammonium ion concentration during the stirring, the pH on condition of the liquid temperature of 25° C. can be adjusted to fall within the above-described range by adding the sodium hydroxide, and the ammonium ion concentration can be adjusted to fall within the above-described range by adjusting the concentration of the aqueous ammonia solution to be supplied. The pH can be adjusted by controlling the flow rate of the sodium hydroxide using a pH controller.

In the nucleation step, the liquid temperature of the solution may be, for example, 10 to 60° C. in the nucleation step. The nucleation step may be performed, for example, for 1 to 120 minutes. The nucleation step can be performed in an oxidizing atmosphere while introducing nitrogen gas or the like into the reaction vessel, for example.

### Nucleus Growth Step

The nucleus growth step can be a step of performing crystallization by adjusting, inside the reaction vessel, the pH at 9.7 to 10.8 on condition of the liquid temperature of 25° C. and the ammonium ion concentration at 20.0 to 26.4 g/L in the solution having been through the nucleation step, and then performing stirring while maintaining the pH at 9.7 to 10.8 on condition of the liquid temperature of 25° C. and the ammonium ion concentration at 20.0 to 26.4 g/L in the solution having been through the nucleation step. Since the nucleus growth step is performed while the pH on condition of the liquid temperature of 25° C. and the ammonium ion concentration respectively fall within the above-described ranges, the composite hydroxide, in which the secondary particles are suppressed from being sintered in a state in which the secondary particles are aggregated, tends to be likely to be obtained.

In the nucleus growth step, the adjustment of the pH on condition of the liquid temperature of 25° C. and the ammonium ion concentration in the solution having been through the nucleation step can be performed by simultaneously supplying the sodium hydroxide and the ammonia water. The adjustment of the pH on condition of the liquid temperature of 25° C. and the ammonium ion concentration in the solution having been through the nucleation step may be performed with the supply of the aqueous source material metal solution and the aqueous ammonia solution being stopped. After the pH on condition of the liquid temperature of 25° C. and the ammonium ion concentration are adjusted to fall within the above-described ranges, the pH on condition of the liquid temperature of 25° C. is maintained at 9.7 to 10.8 and the ammonium ion concentration is maintained at 20.0 to 26.4 g/L while supplying the aqueous source material metal solution and the aqueous ammonia solution to the reaction vessel, thereby growing the nucleus. The adjustment of the pH on condition of the liquid temperature of 25° C. and the ammonium ion concentration can be performed in the same manner as in the nucleation step.

In the nucleus growth step, the temperature of the solution may be, for example, 10 to 60° C. The nucleus growth step may be performed, for example, for 1 to 24 hours. The nucleus growth step can be performed in an oxidizing atmosphere while introducing nitrogen gas or the like into the reaction vessel, for example.

The nucleus growth step can be ended by stopping the supply of the aqueous source material metal solution and the aqueous ammonia solution. The solution in the reaction vessel is filtered, and the filtrate is cleaned with water and is then dried to obtain the composite hydroxide.

According to the method of producing a composite hydroxide, the composite hydroxide, in which the secondary particles are suppressed from being sintered in a state in which the secondary particles are aggregated, is obtained, with the result that in a below-described method of producing a composite oxide (positive electrode active material), a pulverization process for pulverizing aggregated composite oxide is readily performed, or a pulverization step of pulverizing the composite oxide becomes unnecessary.

### Composite Hydroxide

The composite hydroxide of the present disclosure is secondary particles in each of which a plurality of primary particles are aggregated, a crystallite size Sp in a direction parallel to a (001) plane (hereinafter, also referred to as crystallite size Sp) is 300 nm to 500 nm, and a crystallite size Sv in a direction perpendicular to the (001) plane (hereinafter, also referred to as crystallite size Sv) is 100 nm to 300 nm. A ratio (Lp/Lv) (hereinafter, also referred to as a ratio (Lp/Lv)) of a length Lp of each of the primary particles in the direction parallel to the (001) plane (hereinafter, also referred to as length Lp) to a length Lv of the primary particle in the direction perpendicular to the (001) plane (hereinafter, also referred to as length Lv) when observed with a scanning electron microscope (hereinafter, also referred to as SEM) is 10 or more. The primary particles are aggregated in a state in which both the directions parallel to the (001) plane and the directions perpendicular to the (001) plane are oriented randomly. Since the composite hydroxide of the present disclosure has crystallite sizes Sp and Sv respectively falling in the above-described ranges and at least a part of the plurality of primary particles is aggregated randomly, the secondary particles tend to be likely to be suppressed from being sintered in a state in which the secondary particles are aggregated in a calcination step (hereinafter, also referred to as calcination process) of the process of producing a positive electrode active material.

The composite hydroxide can be produced by the above-described production method. The composite hydroxide is a composite hydroxide containing Ni and Mn, may be preferably a composite hydroxide (NCM composite hydroxide) containing Ni, Mn and Co, and may be more preferably a compound represented by the above-described formula (i).

Crystallite size Sp and crystallite size Sv can be calculated by introducing, into the Scherrer equation, the values of the full widths at half maximums of intensities I001 and I100 of the diffraction peaks of the secondary particles as found by an X-ray diffraction method (XRD). Since crystallite size Sp and crystallite size Sv fall within the above-described ranges, the growth of the primary particles by the calcination process becomes slow to reduce contact between the secondary particles due to rapid growth, with the result that the secondary particles tend to be likely to be suppressed from being sintered in a state in which the secondary particles are aggregated. Crystallite size Sp may be, for example, 350 to 450 nm. Crystallite size Sv may be, for example, 150 to 250 nm.

The ratio (Lp/Lv) can be calculated from lengths Lv and Lp of each of the primary particles as measured from the SEM observation image of the surface of the secondary particle. Lengths Lv and Lp can be measured in accordance with a method described in the below-described section of Examples. Since the ratio (Lp/Lv) falls within the above-described range, the growth of the primary particles by the calcination process becomes slow to reduce contact between the secondary particles due to rapid growth, with the result that the secondary particles tend to be likely to be suppressed from being sintered in a state in which the secondary particles are aggregated. The ratio (Lp/Lv) may be, for example, 10.3 or more or 10.4 or more.

The composite hydroxide is secondary particles in each of which at least a part of the plurality of primary particles is randomly aggregated. The expression “randomly aggregated” means a state in which the plurality of primary particles are aggregated such that the directions of the plurality of primary particles parallel to the (001) plane are not regularly arranged when the surface of the secondary particle is observed with an SEM, and does not include, for example, a state in which the directions of the plurality of primary particles parallel to the (001) plane are arranged in a certain direction, a state in which the directions of the plurality of primary particles parallel to the (001) plane extend radially from the center of the secondary particle, and the like. The composite hydroxide is preferably secondary particles in each of which 50% or more of the plurality of primary particles are randomly aggregated, is more preferably secondary particles in each of which 70% or more of the plurality of primary particles are randomly aggregated, and is further preferably secondary particles in each of which all of the primary particles are randomly aggregated.

The number of primary particles included in each secondary particle may be any plural number of primary particles, and may be, for example, 2 or more, 50 or more, 100 or more, 1000 or more, or 10,000 or more, and may be, for example, 1,000,000 or less.

The average particle size of the secondary particles is 2.0 to 7.0 μm. Generally, in a composite hydroxide having an average particle size falling within the above-described range, secondary particles tend to be likely to be sintered with the secondary particles being aggregated in a calcination process; however, even though the average particle size of the composite hydroxide of the present disclosure falls within the above-described range, the secondary particles tend to be less likely to be sintered with the secondary particles being aggregated in the calcination process. In the present specification, the average particle size of the secondary particles may be a particle size D50 corresponding to 50% of cumulation of frequencies from the smallest particle size in a volume-based particle size distribution. The volume-based particle size distribution can be measured by a particle size distribution measurement apparatus.

The BET specific surface area of the secondary particles may be, for example, 10 m²/g. The BET specific surface area can be measured using a flow-type gas adsorption specific surface area measurement apparatus. Since the BET specific surface area of the secondary particles falls within the above-described range, reactivity with lithium is decreased in the calcination step of the process of producing a positive electrode active material, with the result that the secondary particles tend to be likely to be suppressed from being sintered in a state in which the secondary particles are aggregated.

In the secondary particle, the ratio (I011/I001) of intensity I011 of the diffraction peak of the (011) plane to intensity 1001 of the diffraction peak of the (001) plane can be found by XRD to be 1.00 or more. When the ratio (I011/I001) falls within the above-described range, the growth of the primary particles by the calcination process becomes slow to reduce contact between the secondary particles due to the rapid growth, with the result that the secondary particles tend to be likely to be suppressed from being sintered in a state in which the secondary particles are aggregated. The ratio (I011/I001) may be, for example, 1.02 or more, 1.10 or less, or 1.05 or less.

Since the secondary particles are likely to be suppressed from being sintered in a state in which the secondary particles are aggregated in the calcination step of the process of producing a positive electrode active material, improvement of a packing property of the positive electrode active material is accordingly promoted in the positive electrode and the composite hydroxide is therefore suitable as a precursor of the positive electrode active material.

### Method of Producing Composite Oxide

A method of producing a composite oxide according to the present disclosure includes the above-described method of producing a composite hydroxide. The method of producing a composite oxide can further include: a mixing step of mixing the composite hydroxide and Li to obtain a mixture; and a calcination step of calcining the mixture.

In the mixing step, the composite hydroxide and Li can be mixed such that a ratio of the number of atoms of Li to the total number of atoms of metal elements other than Li in the composite oxide is, for example, 1.0 to 1.3.

In the calcination step, a temperature at which the mixture is calcined can be, for example, 700 to 1000° C. A calcination time for the mixture can be, for example, 3 to 10 hours. The calcination step can be performed in an oxidizing atmosphere.

According to the method of producing an NCM composite oxide including the above-described method of producing a composite hydroxide, the positive electrode active material, in which the secondary particles are suppressed from being sintered in a state in which the secondary particles are aggregated, is likely to be obtained, with the result that a pulverization process for pulverizing aggregated composite oxide is readily performed, or a pulverization step of pulverizing the composite oxide becomes unnecessary.

### Composite Oxide

The composite oxide of the present disclosure includes a calcined product of the mixture of the composite hydroxide and lithium described above. The composite oxide of the present disclosure can be obtained by the above-described method of producing a composite oxide. The composite oxide may be a composite oxide containing Li, Ni and Mn, and may be preferably a composite oxide containing Li, Ni, Mn and Co.

The composite oxide may be secondary particles in each of which a plurality of primary particles are aggregated.

The average particle size of the composite oxide is 2.0 to 7.0 μm.

The composite oxide may be a lamellar metal oxide represented by, for example, the following formula (ii):
Li₁₋ₐ₁Ni_{1-x-y-z}COₓMn_{y}M_{z} (ii), where
−0.3<a1<0.3,0<x<0.5, 0<y<0.5, 0≤z<0.05, and

M is one or more elements selected from a group consisting of Al, Ti, Zr, B, Mg, Fe, Cu, Zn, Sn, Na, K, Ba, Sr, Ca, W, Mo, Nb, Si, V, Cr and Ge.

Since the secondary particles are suppressed from being sintered in a state in which the secondary particles are aggregated, improvement of the packing property of the positive electrode is promoted and the composite oxide is therefore suitable for a positive electrode active material of a battery. A ratio of particles sintered in a state in which the particles are aggregated in the composite oxide may be, for example, 14% or less, 7% or less, or 5% or less. When the ratio of the particles sintered in a state in which the particles are aggregated in the composite oxide falls within the above-described range, the packing property in the positive electrode active material tends to be likely to be improved. The ratio of the particles sintered in a state in which the particles are aggregated is measured in accordance with the method described in the below-described section of Examples.

Hereinafter, the present disclosure will be described more in detail with reference to examples.

### EXAMPLES

### Measurement of Average Particle Size

Each of the average particle sizes of composite hydroxides produced in examples of the present disclosure and comparative examples was measured using a volume-integrated value measured using a commercially available laser light diffraction scattering type particle size analyzer.

### Measurement of BET Specific Surface Area

Each of the BET specific surface areas of the composite hydroxides produced in the examples of the present disclosure and the comparative examples was measured using a commercially available flow-type gas adsorption specific surface area measurement apparatus.

### Measurement of Crystallite Sizes and Peak Intensity Ratio

A commercially available X-ray diffractometer was used to measure a crystallite size Sp in a direction parallel to a (001) plane and a crystallite size Sv in a direction perpendicular to the (001) plane in each of the composite hydroxides produced in the examples of the present disclosure and the comparative examples. Further, a ratio (I011/I001) of a peak intensity I011 of a (011) plane to a peak intensity I001 of the (001) plane was calculated.

### Method of Measuring Lengths of Primary Particle

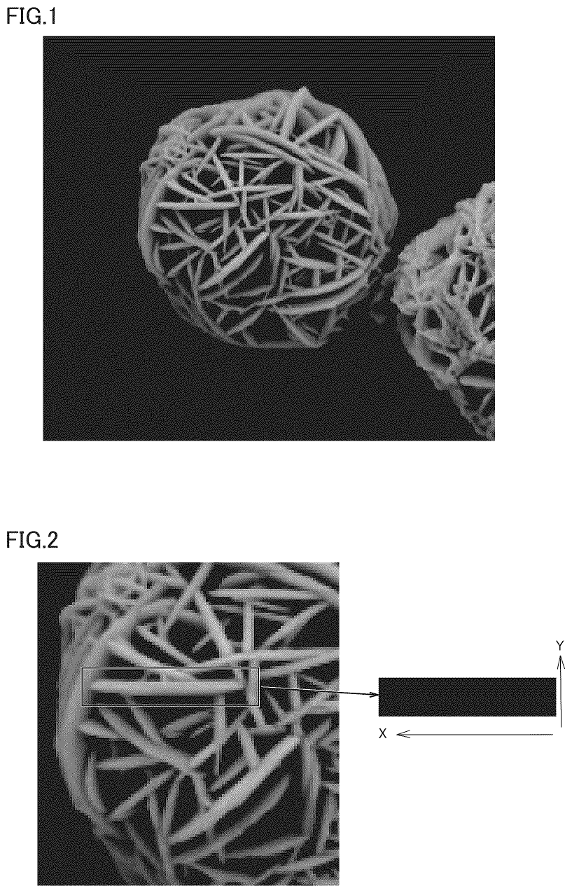

Each of the composite hydroxides produced in the examples of the present disclosure and the comparative examples was observed with a commercially available SEM. The primary particles are extracted from the measured SEM image using image analysis software so as to calculate a length Lp of each of the primary particles in the direction parallel to the (001) plane and a length Lv of the primary particle in the direction perpendicular to the (001) plane. A ratio (Lp/Lv) of length Lp of the primary particle in the direction parallel to the (001) plane to length Lv of the primary particle in the direction perpendicular to the (001) plane was calculated using the calculated lengths. In FIG. 2, the X direction is parallel to the (001) plane, and the Y direction is perpendicular to the (001) plane.

Evaluation of Ratio of Particles Sintered in State in which Particles are Aggregated

A cross section of the composite oxide was cut out by ion milling. The cross section was observed with a commercially available SEM to obtain an SEM image.

The average particle size of the particles was found from the obtained image. A particle larger than 8 μm was regarded as a particle sintered in a state in which a plurality of particles were aggregated, and a ratio of particles each larger than 8 μm among 100 particles was found as a ratio (%) (also referred to as sintering ratio) of particles having been through calcination and sintered in a state in which the particles were aggregated.

### Example 1

### Production of Composite Hydroxide

### Preparation of Aqueous Ammonia Solution

28 wt % of ammonia water was used to prepare 2 L of aqueous ammonia solution having an ammonium ion concentration of 11.5 g/L. The 2 L of aqueous ammonia solution prepared was introduced into a 5L reaction vessel, nitrogen gas was introduced thereinto such that an oxygen concentration in the vessel was 1.0 volume % or less, and stirring was performed at 800 rpm. The solution in the reaction vessel was adjusted to 40° C., an appropriate amount of 30 wt % of aqueous sodium hydroxide solution was introduced to adjust the pH to 13.0 on condition of the liquid temperature of 25° C.

### Preparation of Aqueous Source Material Metal Solution

Then, nickel sulfate, cobalt sulfate and manganese sulfate were dissolved in water to attain a molar ratio of 80:10:10, thereby preparing 1.5 mol/L of aqueous source material metal solution.

### Nucleation Step

The prepared aqueous source material metal solution and an aqueous ammonia solution were supplied to the reaction vessel at an appropriate timing so as to attain a molar ratio of 1:1, and stirring was performed while maintaining the pH at 13.0 on condition of the liquid temperature of 25° C., thereby performing crystallization for 60 minutes. The pH on condition of the liquid temperature of 25° C. was controlled by adjusting the flow rate of sodium hydroxide using a pH controller. On this occasion, the concentration of the aqueous ammonia solution to be supplied was adjusted to maintain the ammonium ion concentration at 11.5 g/L in the reaction solution. Hereinafter, the pH on condition of the liquid temperature of 25° C. in the nucleation step is also referred to as previous pH. Moreover, the ammonium ion concentration in the reaction solution in the nucleation step is also referred to as initial NH₃ concentration.

### Nucleus Growth Step

After the end of the nucleation step, sulfuric acid was gradually supplied such that the pH of the solution in the reaction vessel on condition of the liquid temperature of 25° C. was 10.7, and at the same time, 28 wt % of ammonia water was supplied to adjust the ammonium ion concentration to 21.0 g/L in the reaction solution. After the adjustment, the supply of the liquid to the reaction vessel was resumed. On this occasion, the concentration of 28 wt % of the ammonia water to be supplied was adjusted to maintain the ammonium ion concentration at 21.0 g/L in the reaction solution. Crystallization was continued for 8 hours while maintaining the pH at 10.7 (subsequent pH) on condition of the liquid temperature of 25° C. Thereafter, the supply of the solution was stopped to end the crystallization, and the generated product was filtered, cleaned with water, and dried in this order, thereby obtaining the composite hydroxide of Example 1. It should be noted that an atmosphere in each of the nucleation step and the nucleus growth step was a non-oxidizing atmosphere. Hereinafter, the pH on condition of the liquid temperature of 25° C. in the nucleus growth step is also referred to as subsequent pH. Moreover, the ammonium ion concentration in the reaction solution in the nucleus growth step is also referred to as final NH₃ concentration. An SEM observation image of the composite hydroxide of Example 1 is shown in FIG. 1. The composite hydroxide of Example 1 was secondary particles in each of which all the primary particles were randomly aggregated.

### Production of Composite Oxide

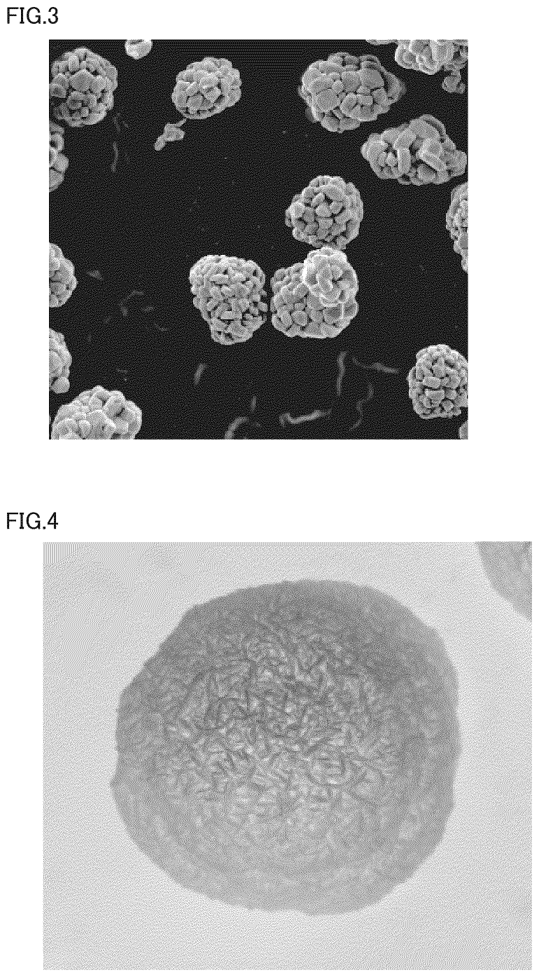

The composite hydroxide and a lithium compound were mixed such that a ratio of the number of atoms of lithium to the total number of atoms of metal elements other than lithium was 1.10, and the mixture was held under a calcination condition of a temperature of 860° C. for 7 hours in an oxidizing atmosphere, thereby obtaining a composite oxide of Example 1. The result is shown in Table 1. An SEM observation image of the composite oxide of Example 1 is shown in FIG. 3.

### Example 2

A composite hydroxide and a composite oxide of an Example 2 were produced in the same manner as in Example 1 except that: in (Preparation of Aqueous Ammonia Solution), an aqueous ammonia solution having an ammonium ion concentration of 10.6 g/L and a pH of 13.2 on condition of a liquid temperature of 25° C. was prepared; in (Preparation of Aqueous Source Material Metal Solution), nickel sulfate, cobalt sulfate, manganese sulfate and zirconium sulfate were dissolved in water to attain a molar ratio of 69.9:14.9:14.9:0.3 so as to prepare 1.6 mol/L of aqueous source material metal solution; in (Nucleation Step), crystallization was performed while maintaining the pH (previous pH) at 13.2 on condition of the liquid temperature of 25° C. and the ammonium ion concentration (initial NH₃ concentration) at 10.6 g/L in the solution in the reaction vessel; and in (Nucleus Growth Step), the pH (subsequent pH) on condition of the liquid temperature of 25° C. was adjusted to 10.1 and the ammonium ion concentration (final NH₃ concentration) was adjusted to 24.1 g/L in the solution in the reaction vessel, and crystallization was then performed while maintaining the pH (subsequent pH) at 10.1 on condition of the liquid temperature of 25° C. and the ammonium ion concentration at 24.1 g/L. The result is shown in Table 1.

### Comparative Example 1

A composite hydroxide and a composite oxide were produced in the same manner as in Example 1 except that: in (Preparation of Aqueous Ammonia Solution), an aqueous ammonia solution having an ammonium ion concentration of 10.6 g/L and a pH of 11.5 on condition of a liquid temperature of 25° C. was prepared; in (Nucleation Step), crystallization was performed while maintaining the pH (previous pH) at 11.5 on condition of the liquid temperature of 25° C. and the ammonium ion concentration (initial NH₃ concentration) at 10.6 g/L in the solution in the reaction vessel; and in (Nucleus Growth Step), the pH (subsequent pH) on condition of the liquid temperature of 25° C. was adjusted to 10.6 and the ammonium ion concentration (final NH₃ concentration) was adjusted to 21.0 g/L in the solution in the reaction vessel, and crystallization was then performed while maintaining the pH (subsequent pH) at 10.6 on condition of the liquid temperature of 25° C. and the ammonium ion concentration (final NH₃ concentration) at 21.0 g/L. The result is shown in Table 1.

### Comparative Example 2

A composite hydroxide and a composite oxide were produced in the same manner as in Example 1 except that: in (Preparation of Aqueous Ammonia Solution), an aqueous ammonia solution having an ammonium ion concentration of 10.6 g/L and a pH of 13.0 on condition of a liquid temperature of 25° C. was prepared; in (Nucleation Step), crystallization was performed while maintaining the pH (previous pH) at 13.0 on condition of the liquid temperature of 25° C. and the ammonium ion concentration (initial NH₃ concentration) at 10.6 g/L in the solution in the reaction vessel; and in (Nucleus Growth Step), the pH (subsequent pH) on condition of the liquid temperature of 25° C. was adjusted to 11.5 and the ammonium ion concentration (final NH₃ concentration) was adjusted to 21.0 g/L in the solution in the reaction vessel, and crystallization was then performed while maintaining the pH (subsequent pH) at 11.5 on condition of the liquid temperature of 25° C. and the ammonium ion concentration (final NH₃ concentration) at 21.0 g/L. The result is shown in Table 1.

### Comparative Example 3

A composite hydroxide was produced in the same manner as in Example 1 except that: in (Preparation of Aqueous Ammonia Solution), an aqueous ammonia solution having an ammonium ion concentration of 10.6 g/L and a pH of 13.0 on condition of the liquid temperature of 25° C. was prepared; in (Nucleation Step), crystallization was performed while maintaining the pH (previous pH) at 13.0 on condition of a liquid temperature of 25° C. and the ammonium ion concentration (initial NH₃ concentration) at 10.6 g/L in the solution in the reaction vessel; and in (Nucleus Growth Step), the pH (subsequent pH) on condition of the liquid temperature of 25° C. was adjusted to 9.3 and the ammonium ion concentration (final NH₃ concentration) was adjusted to 21.0 g/L in the solution in the reaction vessel, and crystallization was then performed while maintaining the pH (subsequent pH) at 9.3 on condition of the liquid temperature of 25° C. and the ammonium ion concentration (final NH₃ concentration) at 21.0 g/L. The composite hydroxide cannot be crystallized to have uniform particle size and particle shape.

### Comparative Example 4

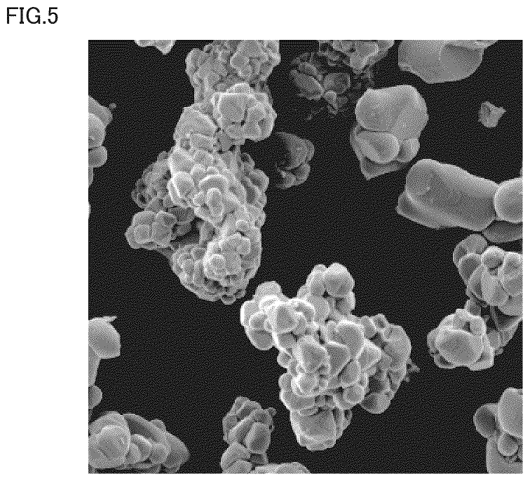

A composite hydroxide and a composite oxide were produced in the same manner as in Example 1 except that: in (Preparation of Aqueous Ammonia Solution), an aqueous ammonia solution having an ammonium ion concentration of 9.6 g/L and a pH of 13.3 on condition of a liquid temperature of 25° C. was prepared; in (Nucleation Step), crystallization was performed while maintaining the pH (previous pH) at 13.3 on condition of the liquid temperature of 25° C. and the ammonium ion concentration (initial NH₃ concentration) at 9.6 g/L in the solution in the reaction vessel; and in (Nucleus Growth Step), the pH (subsequent pH) on condition of the liquid temperature of 25° C. was adjusted to 10.6 and the ammonium ion concentration (final NH₃ concentration) was adjusted to 13.3 g/L in the solution in the reaction vessel, and crystallization was then performed while maintaining the pH (subsequent pH) at 10.6 on condition of the liquid temperature of 25° C. and the ammonium ion concentration (final NH₃ concentration) at 13.3 g/L. The result is shown in Table 1. SEM observation images of the composite hydroxide and the composite oxide are shown in FIGS. 4 and 5, respectively.

### Comparative Example 5

A composite hydroxide and a composite oxide were produced in the same manner as in Example 1 except that: in (Preparation of Aqueous Ammonia Solution), an aqueous ammonia solution having an ammonium ion concentration of 4.7 g/L and a pH of 12.8 on condition of a liquid temperature of 25° C. was prepared; in (Nucleation Step), crystallization was performed while maintaining the pH (previous pH) at 12.8 on condition of the liquid temperature of 25° C. and the ammonium ion concentration (initial NH₃ concentration) at 4.7 g/L in the solution in the reaction vessel; and in (Nucleus Growth Step), the pH (subsequent pH) on condition of the liquid temperature of 25° C. was adjusted to 10.8 and the ammonium ion concentration (final NH₃ concentration) was adjusted to 21.0 g/L in the solution in the reaction vessel, and crystallization was then performed while maintaining the pH (subsequent pH) at 10.8 on condition of the liquid temperature of 25° C. and the ammonium ion concentration (final NH₃ concentration) at 21.0 g/L. The result is shown in Table 1.

### Comparative Example 6

A composite hydroxide and a composite oxide were produced in the same manner as in Example 1 except that: in (Preparation of Aqueous Ammonia Solution), an aqueous ammonia solution having an ammonium ion concentration of 14.2 g/L and a pH of 12.8 on condition of a liquid temperature of 25° C. was prepared; in (Nucleation Step), crystallization is performed while maintaining the pH (previous pH) at 12.8 on condition of the liquid temperature of 25° C. and the ammonium ion concentration (initial NH₃ concentration) at 14.2 g/L in the solution in the reaction vessel; and in (Nucleus Growth Step), the pH (subsequent pH) on condition of the liquid temperature of 25° C. was adjusted to 10.6 and the ammonium ion concentration (final NH₃ concentration) was adjusted to 21.0 g/L in the solution in the reaction vessel, and crystallization was then performed while maintaining the pH (subsequent pH) at 10.6 on condition of the liquid temperature of 25° C. and the ammonium ion concentration (final NH₃ concentration) at 21.0 g/L. The result is shown in Table 1.

### Comparative Example 7

A composite hydroxide was produced in the same manner as in Example 1 except that: in (Preparation of Aqueous Ammonia Solution), an aqueous ammonia solution having an ammonium ion concentration of 9.6 g/L and a pH of 13.0 on condition of a liquid temperature of 25° C. was prepared; in (Nucleation Step), crystallization was performed while maintaining the pH (previous pH) at 13.0 on condition of the liquid temperature of 25° C. and the ammonium ion concentration (initial NH₃ concentration) at 9.6 g/L in the solution in the reaction vessel; and in (Nucleus Growth Step), the pH (subsequent pH) on condition of the liquid temperature of 25° C. was adjusted to 10.6 and the ammonium ion concentration (final NH₃ concentration) was adjusted to 29.2 g/L in the solution in the reaction vessel, and crystallization was then performed while maintaining the pH (subsequent pH) at 10.6 on condition of the liquid temperature of 25° C. and the ammonium ion concentration (final NH₃ concentration) at 29.2 g/L. The composite hydroxide could not have an intended composition.

### Comparative Example 8

A composite hydroxide was produced in the same manner as in Example 1 except that: in (Preparation of Aqueous Ammonia Solution), an aqueous ammonia solution having an ammonium ion concentration of 9.5 g/L and a pH of 13.0 on condition of a liquid temperature of 25° C. was prepared; in (Nucleation Step), crystallization was performed while maintaining the pH (previous pH) at 13.0 on condition of the liquid temperature of 25° C. and the ammonium ion concentration (initial NH₃ concentration) at 9.5 g/L in the solution in the reaction vessel; in (Nucleus Growth Step), the pH (subsequent pH) on condition of the liquid temperature of 25° C. was adjusted to 10.7 and the ammonium ion concentration (final NH₃ concentration) was adjusted to 21.0 g/L in the solution in the reaction vessel, and crystallization was then performed while maintaining the pH (subsequent pH) at 10.7 on condition of the liquid temperature of 25° C. and the ammonium ion concentration (final NH₃ concentration) at 21.0 g/L; and an atmosphere in each of the nucleation step and the nucleus growth step was an oxidizing atmosphere. The composite hydroxide could not be crystallized to have uniform particle size and particle shape.

TABLE 1

| | | | Initial | Final | | Average | BET | | | | | |
|---|---|---|---|---|---|---|---|---|---|---|---|---|
| | | | NH₃ | NH₃ | | Particle | Specific | Ratio | | | | Sintering |
| | Previous | Subsequent | Concentration | Concentration | | Size | Surface | (I011/ | Length | Length | Ratio | Ratio |
| | pH | pH | (g/L) | (g/L) | Atmosphere | (μm) | (m²/g) | I001) | Sp | Sv | (Lp/Lv) | (%) |
| Comp. | 11.5 | 10.6 | 10.6 | 21.0 | Non- | 10.0 | 17.2 | 0.84 | 321 | 276 | 10.2 | 7 |
| Ex. 1 | | | | | Oxidizing | | | | | | | |
| Comp. | 13.0 | 11.5 | 10.6 | 21.0 | Non- | 4.4 | 9.4 | 0.97 | 169 | 182 | 4.3 | 27 |
| Ex. 2 | | | | | Oxidizing | | | | | | | |
| Comp | 13.0 | 9.3 | 10.6 | 21.0 | Non- | — | | | | | | |
| Ex. 3 | | | | | Oxidizing | | | | | | | |
| Comp. | 13.3 | 10.6 | 9.6 | 13.3 | Non- | 4.6 | 14.6 | 0.81 | 149 | 166 | 7.2 | 15 |
| Ex. 4 | | | | | Oxidizing | | | | | | | |
| Comp. | 12.8 | 10.8 | 4.7 | 21.0 | Non- | 3.8 | 27.0 | 0.74 | 228 | 178 | 5.6 | 18 |
| Ex. 5 | | | | | Oxidizing | | | | | | | |
| Comp | 12.8 | 10.6 | 14.2 | 21.0 | Non- | 4.4 | 6.7 | 0.98 | 321 | 183 | 2.2 | 34 |
| Ex. 6 | | | | | Oxidizing | | | | | | | |
| Comp. | 13.0 | 10.6 | 9.6 | 29.2 | Non- | — | | | | | | |
| Ex. 7 | | | | | Oxidizing | | | | | | | |
| Comp | 13.0 | 10.7 | 9.5 | 21.0 | Oxidizing | — | | | | | | |
| Ex. 8 | | | | | | | | | | | | |
| Ex. 1 | 13.0 | 10.7 | 11.5 | 21.0 | Non- | 4.2 | 7.3 | 1.02 | 422 | 223 | 10.4 | 3 |
| | | | | | Oxidizing | | | | | | | |
| Ex. 2 | 13.2 | 10.1 | 10.6 | 24.1 | Non- | 4.6 | 9.2 | 1.06 | 433 | 187 | 12.4 | 4 |
| | | | | | Oxidizing | | | | | | | |

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A method of producing a composite hydroxide, wherein
the composite hydroxide contains nickel and manganese,
the method comprising:
by supplying an aqueous ammonia solution and sodium hydroxide to an aqueous solution including a compound containing nickel and a compound containing manganese, generating a nucleus while maintaining a pH at 12.0 to 13.5 on condition of a liquid temperature of 25° C. and an ammonium ion concentration at 5.3 to 11.7 g/L; and
growing the nucleus while maintaining the pH at 9.7 to 10.8 on condition of the liquid temperature of 25° C. and the ammonium ion concentration at 20.0 to 26.4 g/L.

2. The method of producing a composite hydroxide according to claim 1, wherein
the composite hydroxide is a compound represented by the following formula (i):
Ni_{1-x-y-z}COₓMn_{y}M_{z} (i), where
0<x<0.5, 0<y<0.5, and 0≤z<0.05, and
M is one or more elements selected from a group consisting of Al, Ti, Zr, B, Mg, Fe, Cu, Zn, Sn, Na, K, Ba, Sr, Ca, W, Mo, Nb, Si, V, Cr and Ge.

3. The method of producing a composite hydroxide according to claim 1, wherein each of the generating the nucleus and the growing the nucleus is performed in a non-oxidizing atmosphere.

4. A method of producing a composite oxide, the method comprising the method of producing a composite hydroxide according to claim 1.

5. The method of producing a composite oxide according to claim 4, the method not comprising pulverizing.

6. A composite hydroxide, wherein
the composite hydroxide is secondary particles in each of which a plurality of primary particles are aggregated,
a crystallite size Sp in a direction parallel to a (001) plane is 300 nm to 500 nm,
a crystallite size Sv in a direction perpendicular to the (001) plane is 100 nm to 300 nm,
a ratio (Lp/Lv) of a length Lp of each of the primary particles in the direction parallel to the (001) plane to a length Lv of the primary particle in the direction perpendicular to the (001) plane when observed with a scanning electron microscope is 10 or more,
at least a part of the plurality of primary particles is aggregated randomly,
an average particle size of the secondary particles is 2.0 to 7.0 μm, and
the composite hydroxide contains nickel and manganese.

7. The composite hydroxide according to claim 6, wherein a BET specific surface area of the secondary particles is 10 m²/g or less.

8. The composite hydroxide according to claim 6, wherein a ratio (I011/I001) of an intensity I011 of a diffraction peak of a (011) plane to an intensity I001 of a diffraction peak of the (001) plane in each of the secondary particles is found by an X-ray diffraction method to be 1.00 or more.

9. A composite oxide comprising a calcined product of a mixture of the composite hydroxide according to claim 6 and lithium.
